(19) United States
(12) Patent Application Publication
(10) Pub. No.: US 2007/0205210 A1
(43) Pub. Date: Sep. 6, 2007

(54) EGG COOKING UTENSIL

(76) Inventor: Brian Powell, Shifnal (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/573,642

(22) PCT Filed: Aug. 24, 2005
(86) PCT No.: PCT/GB05/03277

§ 371 Date: Feb. 12, 2007

(30) Foreign Application Priority Data
Sep. 3, 2004 (GB) 0419540.0

(51) Int. Cl. A21B 1/08

(52) U.S. Cl. 220/912; 126/20

(57) ABSTRACT

A pan that contains ridges (1) that surround the cooking egg, with a steam producing area (2). The pan shall be shallow with a close fitting lid made from heat reflective material. The shape of the ridges is preferably elliptical but can be any shape.

The invention relates to an egg cooking utensil.

This invention solves the problems of cooking eggs by frying or poaching. When frying an egg one needs quite a lot of oil, some skill to cook an egg of consistent quality, i.e. with no burnt parts, or with a soft yolk but still with all the white cooked.

When one requires an egg “over easy” as in America this is to get all the white cooked whilst still keeping a soft yolk This requires a skillet or same and it is very easy to break the yolk.

The pan needs heavy cleaning afterwards, and the egg will always contain a residue of fat, which people nowadays do not want to eat.

With poaching in water, the water must first be heated to the correct temperature. This takes time, and even more skill is required to cook correctly. Often the egg breaks up in the water.

By using a traditional egg poaching pan, one has to test the eggs several times, and inevitably some white is left uncooked. This method always takes the longest time.

This invention provides a means of cooking eggs very consistently and very quickly with no burnt parts, uncooked white or fat residue but leaving the yolk soft. The invention also cooks the eggs to a consistent shape.

There is no quantity of boiling water or hot fat which can be a safety concern.

This invention uses the contact heat at the bottom of the pan together with steam heat within the pan (under the lid) to cook the egg more quickly and consistently. The egg is cooked with virtually no fat. The cooked egg has no fat residue. There is no pan of boiling water or hot fat to clean. The pan can be quickly rinsed clean. The pan cooks eggs always to the same shape, so that the visual quality is always consistent. Water does not come into contact with the eggs so there is no spitting as when frying in oil. The egg will not break up as happens when poaching.

This invention allows the eggs to cook separately from the water by means of ridges that completely surround the cooking egg.

This invention shows a frying pan made generally of steel, cast iron or aluminium or other good conducting materials. The pan could have a non-stick coating but this is not compulsory.

A preferred embodiment of the invention will be described in conjunction with the drawings, which show:

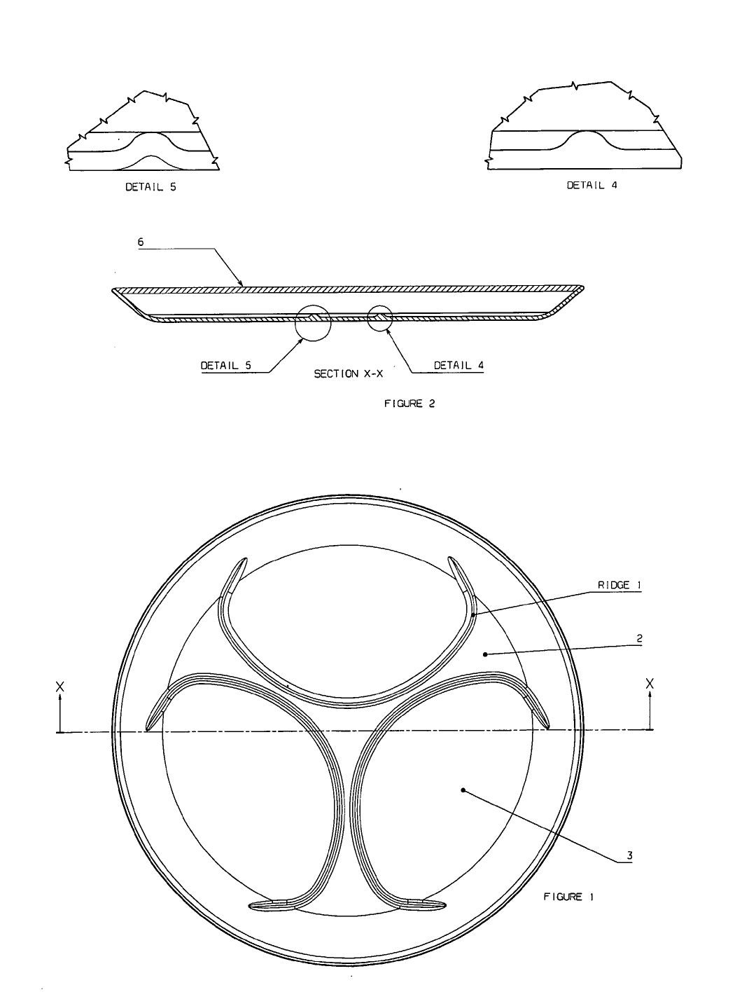

FIG. 1 shows a plan drawing of the pan without the lid (for clarity).

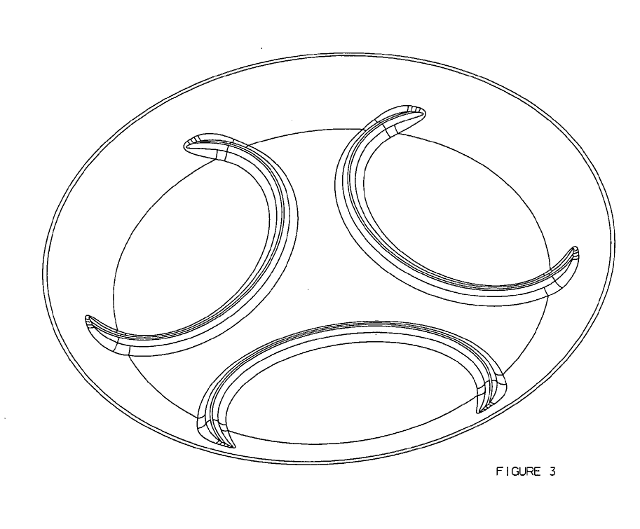

FIG. 2 shows a cross section of the pan.

FIG. 3 shows the detail of the ridges. In this case where the side wall forms part of the continuous ridge.

FIG. 1 shows the ridges (1), flat area to produce steam (2). Egg cooking area (3). Detail 5 shows an indent formed in the bottom of the pan and the upper ridge. Detail 4 shows only an upper ridge. (Use of detail 4 or 5 may be dependant on the manufacturing method).

FIG. 2 shows that the pan is shallow—In that only a little water placed in area (2) will produce enough steam to cook the top of the eggs. Also the water will be completely “boiled away”.

The lid (6) is so designed and made of such material as to reflect the convection heat generated by the steam produced.

The pan has raised ridges, so shaped to keep the egg within them after being broken into them. The ridges totally enclose the egg. The sides of the pan can form part of this continuous ridge. The ridges can be separate from the sides of the pan. The shape of these ridges can be round, square or elliptical or any shape at all. In this drawing the ridges are so formed to cook the eggs to a “natural” shape.

The drawings show a pan with three ridges to cook three eggs, but the pan may contain any number of ridges to cook any quantity of eggs at the same time. In between these shaped ridges, which shape the egg and keep the water away from the egg, is an area where a small amount of water can be placed which will quickly generate steam.

The pan has a dose fitting lid made from a good conductive material, i.e. steel or aluminium. This reflects the heat made from the steam and helps cook the egg from above.

1. A pan-shaped egg-cooking utensil comprising a base with a peripheral side wall, the base being flat on its lower and upper surfaces except where at least one ridge projects upwardly from its upper surface, the at least one ridge being less high than the side wall and together with the side wall forming barriers defining at least one cooking area to accommodate a respective egg and a separate steam-producing area, the barrier around each cooking area being continuous, the utensil having a lid so that the cooking and steam producing areas together with the lid form a small cooking volume which produces three heat sources simultaneously, bottom contact heat, reflective radiant heat and hot contact steam, which heats the top and bottom of the egg so quickly that the white is cooked but the yoke always remains soft.

2. An egg-cooking utensil as claimed in 1 where the base is flat on its lower surface except for at least one groove indented into that surface to form the at least one ridge of the upper surface.

3. An egg cooking utensil as in 1, 2, 3 with shallow ridges which serves to constrict an egg to a “fried egg shape” of consistent size where a small quantity of water boils rapidly, heating up the pan quickly and allowing the top and bottom of the egg to be cooked quickly and in a consistent time.

4. An egg-cooking utensil as claimed in claim 1 or 2 that is shallow.

5. An egg-cooking utensil as claimed in claim 1, 2 or 3 that has a lid made from heat conductive material that will allow steam to escape so that no water remains.

6. An egg-cooking utensil as claimed in any preceding claim where each cooking area is round or square, or any other shape, for example to produce a cooked egg of sandwich shape.

7. An egg-cooking utensil substantially as herein described and illustrated in the accompanying drawings.
